(19) United States
(12) Patent Application Publication
(10) Pub. No.: US 2005/0135975 A1
(43) Pub. Date: Jun. 23, 2005

(54) Quick open-closed device for biochemical equipment

(75) Inventors: Wien-Wei Su, Taoyuan (TW); Yu-Chien Hsiao, Taoyuan (TW); Kuei-Hung Chen, Taoyuan (TW); Hsu- Li-Chung, Taoyuan (TW)

Correspondence Address: TROXELL LAW OFFICE PLLC, SUITE 1404, 5205 LEESBURG PIKE, FALLS CHURCH, VA, 22041, US

(73) Assignee: Exon Science Incorporation

(21) Appl. No.: 10/995,387

(22) Filed: Nov. 24, 2004

(30) Foreign Application Priority Data
Dec. 17, 2003 (TW) 092222103

(51) Int. Cl. B01J 19/00

(52) U.S. Cl. 422/103; 422/130

(57) ABSTRACT

A quick open-closed device for biochemical equipment (1) comprises a socket (2) disposed on the biochemical equipment and a plug (3) for coupling with the socket. The socket is a hollow, cylindrical element, and comprises a cylindrical sidewall (25) and a passage (26) in communication with an interior chamber of the biochemical equipment. The cylindrical sidewall of the socket defines an engaging slot (27), which comprises a guiding portion (271) and a retaining portion (272) connected with each other. The plug has a straight pin (31) for being inserted into the passage of the socket. A peg (312) is provided on the straight pin for rotatively and releasably engaging with the engaging slot of the socket to assembly the plug and the socket together as a unit.

### BACKGROUND OF THE INVENTION

1. Field of the Invention

The present invention relates to a quick open-closed device for biochemical equipment, and particularly relates to a quick open-closed device used with a vessel for microorganism or fungus cultivation and storage, or a vessel for chemical reaction or storage.

2. Description of Prior Art

In the biochemical field, biochemical equipments, such as specific vessels, are generally used for microorganism or fungus cultivation and storage, or for chemical storage or reaction. These kinds of vessels must be strictly isolated to prevent airborne microorganisms, bacteria or other impurities from entering into the vessel to contaminate the cultivated microorganisms or fungus, which results in failure of the cultivation, storage or reaction. Currently available biochemical reaction and storage vessels generally have caps or spigots together with seal rings screwed thereon, so that the contents of the vessel can be isolated from airborne contamination. However, in some specific instances, the cap or spigot of the biochemical vessel must be frequently removed for sampling and assay. For example, when cultivating a microorganism, the cultivating fluid in the vessel is required to be observed and assayed at intervals for collecting the data and monitoring the process. Since the cap or spigot is assembled to the biochemical vessel via screw engagement therebetween, it often takes a relatively long time to unscrew/screw the cap or spigot from/onto the vessel for each sampling and assay. During these unscrewing/screwing processes, foreign microorganisms, bacteria or other airborne impurities may enter into the vessel, which results in failure of the biochemical trial.

One known solution to the above problem is to provide a ring-shaped recess around the opening of the biochemical vessel for containing a certain volume of fuel therein. Before removing the spigot from the vessel, a certain amount of alcohol is poured into the ring-shaped recess and then burned. The high temperature generated by alcohol burning can kill the bacteria or other microorganisms collected around the opening of the vessel, on the spigot and in the surrounding air. However, as the spigot is conventionally screwed onto the vessel, both removal and assembly of the spigot from and to the vessel require tedious manual operation, which results in dangerous long-time exposure of the operator's hand to the high temperature caused by alcohol burning.

Accordingly, to overcome the problems presented in the conventional biochemical vessels, a quick open-closed device for a biochemical vessel is required, which improves the effects of microorganism or fungus cultivation, storage and reaction by keeping the contents of the biochemical sterile, and which effectively protects the operator from long-time exposure to high temperature during opening and closing operations.

### SUMMARY OF THE INVENTION

One object of the present invention is to provide a quick open-closed device for biochemical equipment, which can be quickly opened and closed to effectively prevent the contents of the biochemical equipment from contamination of foreign microorganisms, bacteria or impurities.

Another object of the present invention is to provide a quick open-closed device for biochemical equipment, which protects the operator from long-time exposure to dangerous high temperature when opening or closing the biochemical equipment.

To achieve the above objects of the present invention, a quick open-closed device for biochemical equipment in accordance with the present invention comprises a socket disposed on the biochemical equipment and a plug for coupling with the socket. The socket is a hollow, cylindrical element, and comprises a cylindrical sidewall and a passage in communication with an interior chamber of the biochemical equipment. The cylindrical sidewall of the socket defines an engaging slot, which comprises a guiding portion and a retaining portion connected with each other. The plug has a straight pin for being sealingly inserted into the passage of the socket. A peg is provided on the straight pin for rotatively and releasably engaging with the engaging slot in the cylindrical sidewall of the socket.

According to one aspect of the present invention, a ring-shaped recess may be further defined in the socket for accommodating fuel therein.

According to another aspect of the present invention, an operating portion may be further provided on the plug for facilitating handling of the operator. The operating portion includes a longitudinal post coaxial with the straight pin, and a transverse rotation handle disposed adjacent to the free end of the longitudinal post.

According to a further aspect of the present invention, a seal ring may be further disposed around the straight pin of the plug for ensuring reliable sealing property.

According to yet another aspect of the present invention, the socket may be assembled to the biochemical equipment via various engagements, such as screw engagement. Alternatively, the socket may be integrally formed with the body of the biochemical equipment.

By the provision of the quick open-closed device of the present invention, when assembling the plug to the socket, the peg of the plug can be quickly inserted into the guiding portion of the engaging slot of the socket and then conveniently rotated into the retaining portion of the engaging slot, whereby the plug and socket are assembled together as a unit. When opening the biochemical equipment is desired, it only requires reverse rotation of the plug to displace the peg from the retaining portion of the engaging slot into the guiding portion, whereby the plug can be disassembled from the socket conveniently. Before rotating the plug for removal, fuel, such as alcohol, can be filled into the ring-shaped recess of the socket, and then be burned to effectively kill the bacteria and other microorganisms accumulated on the plug and socket. When the fuel is burned, hot air flow is formed above the quick open-closed device, whereby surrounding impurities are also prevented from entering into the biochemical equipment. Thus, the microorganism or bacterium cultivating fluid in the biochemical equipment is effectively protected from contamination.

Additionally, with the design of the present invention, the peg of the plug can be quickly engaged with and disengaged from the engaging slot of the socket. This helps protect the operator from being long-time exposed to the dangerous high-temperature environment when the operator operates the plug.

### BRIEF DESCRIPTION OF THE DRAWINGS

The present invention may best be understood through the following description with reference to the accompanying drawings, in which:

FIG. 1 is an exploded, perspective view of a quick open-closed device in accordance with the present invention and a biochemical reaction vessel used therewith;

FIG. 2 is a perspective view illustrating the plug and the socket of the quick open-closed device as shown in FIG. 1 engaged with each other in an initial position during a closing operation;

FIG. 3 is a perspective view illustrating the plug and the socket of the quick open-closed device as shown in FIG. 1 engaged with each other in a middle position during a closing operation;

FIG. 4 is a perspective view illustrating the plug and the socket of the quick open-closed device as shown in FIG. 1 engaged with each other in a final position during a closing operation; and

FIG. 5 is a planar view showing a modification to an engaging slot in the socket of the quick open-closed device as shown in FIG. 1.

### DETAILED DESCRIPTION OF THE INVENTION

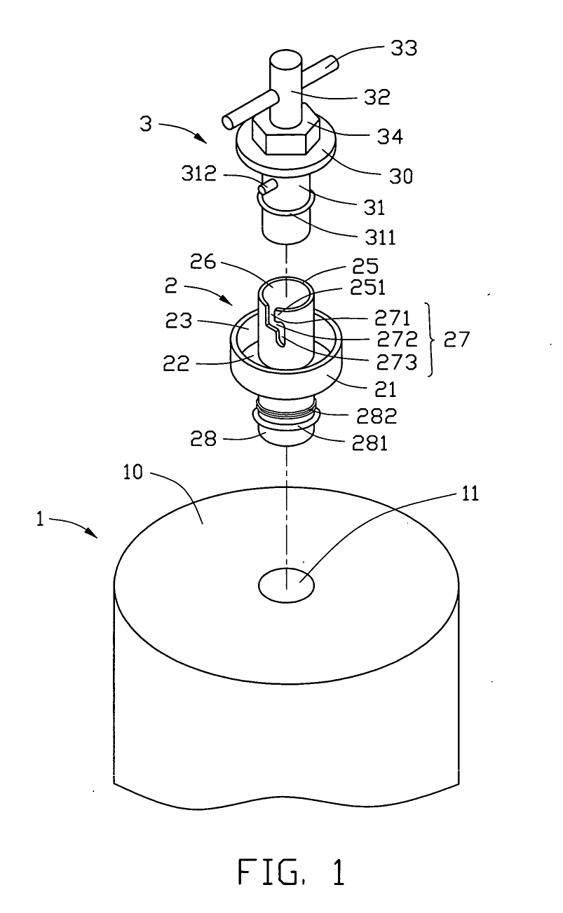

Referring to FIG. 1, a quick open-closed device for biochemical equipment in accordance with the present invention includes a socket 2 and a plug 3 connectable with each other. The socket 2 may be assembled to the biochemical equipment, which shows in this preferred embodiment as a biochemical reaction vessel 1, via screw engagement. The socket 2 is substantially a hollow, cylindrical element and has a cylindrical inner sidewall 25 defining an engaging slot 27. The engaging slot 27 is preferably composed of a guiding portion 271 defined in a top edge of the cylindrical inner sidewall 25 in a direction parallel to the axial line of the socket 2, an retaining portion 272 connecting with the guiding portion 271 and extending in a direction perpendicular to that of the guiding portion 271, and a positioning portion 273 perpendicularly extending from a free end of the retaining portion 272 in a direction opposite to that of the guiding portion 271. The socket 2 further comprises a circumferential wall 21 coaxially surrounding the cylindrical inner sidewall 25. A bottom wall 22 connects the circumferential wall 21 with the cylindrical inner sidewall 25, and a ring-shaped recess 23 is thus defined for containing fuel therein, such as alcohol. A bottom sleeve 28 extends downwardly from the bottom wall 22 with a seal ring 281 disposed adjacent to a free end thereof. The bottom sleeve 28 has male screws 282 disposed around an outer side surface thereof for engaging with a corresponding screw hole 11 defined in the cover 10 of the biochemical reaction vessel 1, so that the socket 2 can be assembled to the biochemical reaction vessel 1. A passage 26 is defined through the socket 2 along the axial line thereof to communicate with the interior chamber of the biochemical reaction vessel 1.

The plug 3 comprises a base 30, a straight pin 31 beneath the base 30 for engaging with the passage 26 of the socket 2, a longitudinal post 32 coaxial with the straight pin 31, a nut 34 connecting the longitudinal post 32 with the base 30, and a transverse rotation handle 33 disposed adjacent to a free end of the longitudinal post 32. The base 30 is in the shape of a disc and has a diameter greater than the given diameter of the passage 26 of the socket 2. The longitudinal post 32 and the transverse rotation handle 33 together constitute an operating portion of the plug 3 for facilitating handling and rotation of the plug 3 by the operator. A seal ring 311 is provided around the straight pin 31 adjacent to a free end thereof for ensuring reliable sealing property when the straight pin 31 is inserted into the passage 26 of the socket 2. The straight pin 31 further has a peg 312 formed thereon for rotatively and releasably engaging with the engaging slot 27 in the cylindrical inner sidewall 25 of the socket 2.

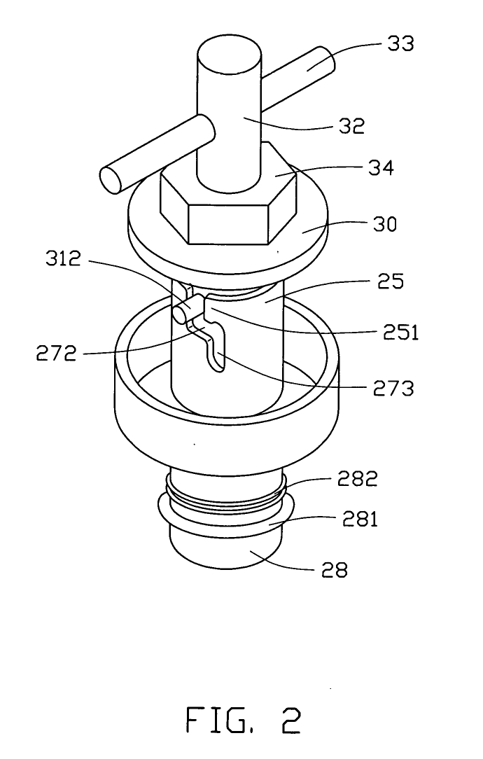

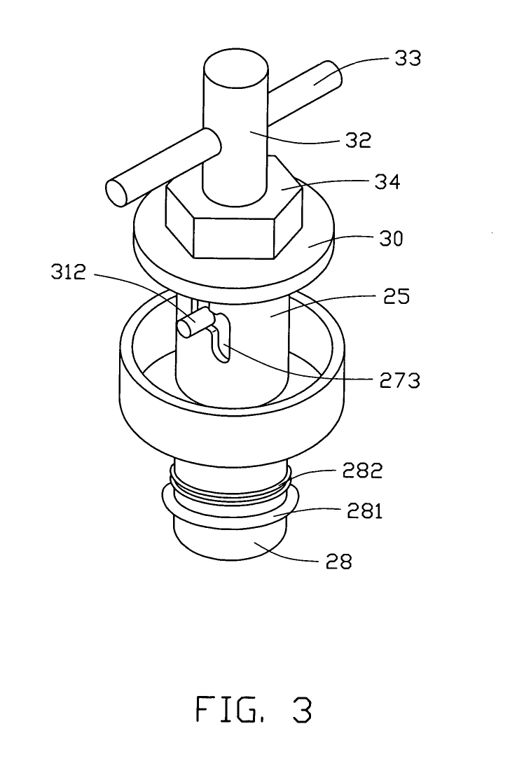

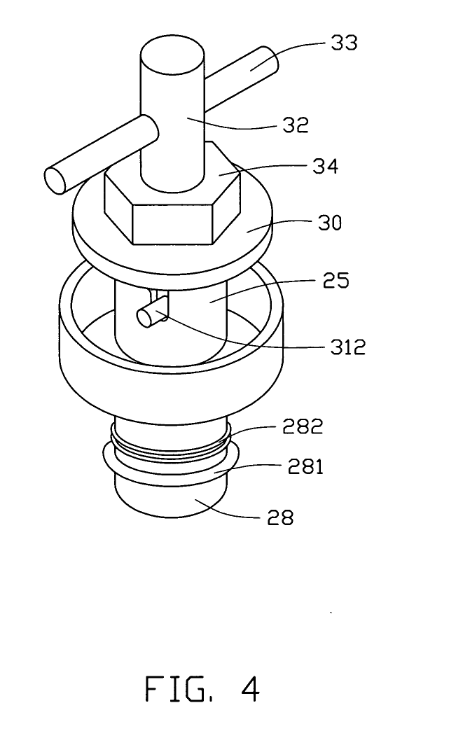

As sequentially shown in FIGS. 2-4, when closing of the quick open-closed device of the biochemical reaction vessel 1 is desired, the straight pin 31 of the plug 3 is first inserted into the passage 26 of the socket 2, the plug 3 is then rotated to adjust the position of the peg 312 so that the peg 312 is aligned with the guiding portion 271 of the engaging slot 27 of the socket 2. After the peg 312 is inserted into the guiding portion 271 of the engaging slot 27 of the socket 2, the plug 3 is further rotated to guide the peg 312 into the retaining portion 272 of the engaging slot 27 of the socket 2. In this position, due to the provision of a stopper 251 above the retaining portion 272 of the engaging slot 27, the straight pin 31 may be retained in the passage 26 of the socket 2 without the risk of being displaced from the socket 2. However, in this position, when the transverse rotation handle 33 of the plug 3 is subject to an accident bump, it is possible that the plug 3 may be caused to rotate, the peg 312 may consequently slide away from the retaining portion 272 and the guiding portion 271 of the engaging slot 27, which finally results in the displacement of the plug 3 from the socket 2. In order to prevent this accident displacement, the straight pin 31 of the plug 3 may be further rotated and inserted into the passage 26 of the socket 2 to slide the peg 312 into the positioning portion 273 of the engaging slot 27. Consequently, even if the transverse rotation handle 33 of the plug 3 were accidently bumped, the plug 3 wouldn't be displaced from the socket 2 any more.

Understandably, when opening of the quick open-closed device of the biochemical reaction vessel 1 is desired, the above-mentioned closing steps may be repeated in a reversed manner. The plug 3 is first upwardly pulled a predetermined distance to slide the peg 312 from the positioning portion 273 of the engaging slot 27 into the retaining portion 272 of the engaging slot 27. The plug 3 is then rotated to further slide the peg 312 from the retaining portion 272 into the guiding portion 271 of the engaging slot 27. Finally, the plug 3 is upwardly moved to disengage from the socket 2. To prevent foreign microorganisms, bacteria or impurities from entering into the biochemical reaction vessel 1, before opening the quick open-closed device, an adequate amount of clean fuel, such as alcohol, can be first filled into the ring-shaped recess 23 of the socket 2, and then be burned for a period of time to effectively kill the bacteria and other microorganisms cumulated on the socket 2 and plug 3. When the fuel is burned, hot air flow is formed above the quick open-closed device, whereby airborne impurities are also prevented from entering into the biochemical reaction vessel 1 via the passage 26 when the plug 3 is removed from the socket 2. Thus, the microorganism or bacterium cultivating fluid in the biochemical reaction vessel 1 can be effectively protected from contamination.

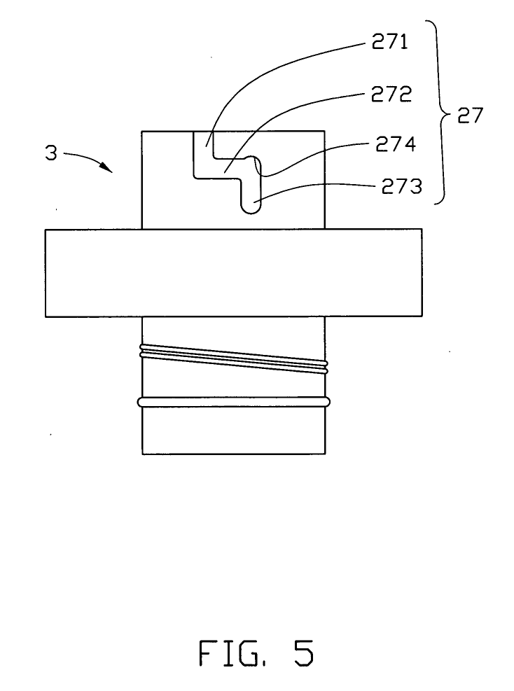

FIG. 5 shows a modification to the engaging slot 27 of the socket 2. Except for the guiding portion 271, the retaining portion 272 and the positioning portion 273, an arcuate portion 274 is further provided at one end of the retaining portion 272 adjacent to the positioning portion 273 for facilitating engaging with the peg 312. According to the concept of the present invention, it is understandable that the guiding portion 271 and the positioning portion 273 of the engaging slot 27 of the socket 2 are not limited to extend in a direction parallel to the axial line of the socket 2 or in a direction parallel to the insertion direction of the plug 3. Correspondingly, the retaining portion 272 of the engaging slot 27 is also not limited to extend in the transverse direction. Additionally, the engaging slot 27 of the socket 2 may be only defined in an inner side surface of the cylindrical sidewall 25 of the socket 2, rather than being defined through inner and outer side surfaces of the cylindrical sidewall 25.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A quick open-closed device for biochemical equipment, comprising:
a socket adapted for being disposed on the biochemical equipment, the socket being a hollow, cylindrical element and comprising a cylindrical sidewall and a passage defined therethrough adapted for communicating with an interior chamber of the biochemical equipment, the cylindrical sidewall defining an engaging slot comprising a guiding portion and a retaining portion communicated with each other; and
a plug having a straight pin sealingly insertable into the passage of the socket, the straight pin having a peg provided thereon, the peg rotatively and releasably engagable with the engaging slot of the socket to assemble the plug and the socket together.

2. The quick open-closed device for biochemical equipment as claimed in claim 1, wherein the socket comprises a ring-shaped recess for containing fuel.

3. The quick open-closed device for biochemical equipment as claimed in claim 2, wherein the socket comprises a bottom sleeve located below the ring-shaped recess and a seal ring disposed around the bottom sleeve adjacent to a free end thereof.

4. The quick open-closed device for biochemical equipment as claimed in claim 3, wherein the bottom sleeve of the socket has male screws formed on an outer side surface thereof adapted for engaging with a corresponding screw hole defined in the biochemical equipment.

5. The quick open-closed device for biochemical equipment as claimed in claim 1, wherein the engaging slot of the socket further comprises a positioning portion extending from a free end of the retaining portion in a direction parallel to and opposite to that of the guiding portion.

6. The quick open-closed device for biochemical equipment as claimed in claim 1, wherein the plug comprises an operating portion for facilitating handling and rotation of the plug during opening and closing operations.

7. The quick open-closed device for biochemical equipment as claimed in claim 6, wherein the operating portion of the plug includes a longitudinal post extending along an axial line of the straight pin and a transverse rotation handle disposed adjacent to a free end of the longitudinal post.

8. The quick open-closed device for biochemical equipment as claimed in claim 1, wherein the straight pin of the plug has a seal ring disposed therearound.

9. A biochemical reaction vessel disposed with a quick open-closed device, the quick open-closed device including a socket and a plug engagable with each other, the socket being a hollow, cylindrical element and comprising a cylindrical sidewall and a passage defined therethrough communicating with an interior chamber of the biochemical reaction vessel, the cylindrical sidewall defining an engaging slot comprising a guiding portion and a retaining portion communicated with each other, the plug having a straight pin sealingly insertable into the passage of the socket, the straight pin having a peg provided thereon, the peg rotatively and releasably engagable with the engaging slot of the socket to assemble the plug and the socket together.

10. The biochemical reaction vessel as claimed in claim 9, wherein the socket comprises a ring-shaped recess.

11. A biochemical reaction vessel disposed with a quick open-closed device, the quick open-closed device including a socket and a plug engagable with each other, the socket defining an engaging slot, the plug having a peg rotatively and releasably engagable with the engaging slot of the socket, the plug tightly sealing the socket for preventing the contents of the biochemical reaction vessel from contamination after the peg engages with the engaging slot of the socket.

12. The biochemical reaction vessel as claimed in claim 11, wherein the socket comprises a ring-shaped recess for containing fuel.

13. The biochemical reaction vessel as claimed in claim 11, wherein the plug comprises a straight pin, and the socket defines a passage in communication with an interior chamber of the biochemical reaction vessel, the straight pin being sealingly insertable into the passage.

14. The biochemical reaction vessel as claimed in claim 13, wherein the straight pin of the plug has a seal ring disposed therearound, and the peg is formed on the straight pin.

15. The biochemical reaction vessel as claimed in claim 13, wherein the plug comprises a base located above the straight pin, the base having a diameter greater than the given diameter of the passage of the socket.

16. The biochemical reaction vessel as claimed in claim 11, wherein the engaging slot of the socket includes a guiding portion extending in the insertion direction of the plug and a retaining portion extending perpendicularly from the guiding portion.

17. The biochemical reaction vessel as claimed in claim 16, wherein the engaging slot of the socket further comprises an arcuate portion provided at a free end of the retaining portion, the arcuate portion extending in a direction parallel to and opposite to the insertion direction of the plug.

18. The biochemical reaction vessel as claimed in claim 16, wherein the engaging slot of the socket further comprises a positioning portion connected with the retaining portion, the positioning portion extending in the insertion direction of the plug and opposite to the guiding portion.

19. The biochemical reaction vessel as claimed in claim 11, wherein the plug comprises a transverse rotation handle at a top end thereof.

20. The biochemical reaction vessel as claimed in claim 11, wherein the socket is integrally formed with a body of the biochemical reaction vessel.
